(19) United States
(12) Patent Application Publication
(10) Pub. No.: US 2019/0319521 A1
(43) Pub. Date: Oct. 17, 2019

(54) ROTOR AND ROTATING ELECTRIC MACHINE INCLUDING ROTOR

(71) Applicant: DENSO CORPORATION, Kariya-city (JP)

(72) Inventor: Takeo MAEKAWA, Kariya-city (JP)

(73) Assignee: DENSO CORPORATION, Kariya-city (JP)

(21) Appl. No.: 16/453,049

(22) Filed: Jun. 26, 2019

Related U.S. Application Data
(63) Continuation of application No. PCT/JP2017/046474, filed on Dec. 25, 2017.

(30) Foreign Application Priority Data
Dec. 26, 2016 (JP) 2016-251981

(51) Int. Cl. H02K 21/04; H02K 1/24; H02K 19/22; H02K 21/14; H02K 1/22; H02K 15/03; H02K 1/27

(52) U.S. Cl. CPC H02K 21/044; H02K 1/24; H02K 19/22; H02K 1/278; H02K 1/226; H02K 15/03; H02K 21/14

(57) ABSTRACT

A rotor includes: a field core having a plurality of claw-shaped magnetic pole portions; a tubular member arranged to cover radially outer surfaces of the claw-shaped magnetic pole portions; a field winding wound on the field core; and a plurality of magnet units each of which includes a permanent magnet arranged between one circumferentially-adjacent pair of the claw-shaped magnetic pole portions and a magnet holder that holds the permanent magnet. The magnet holder has: a pair of circumferential movement restricting portions provided to restrict circumferential movement of the permanent magnet; a first radial movement restricting portion provided to restrict radially inward movement of the permanent magnet; and a pair of second radial movement restricting portions provided to restrict radially inward movement of the magnet holder. Each of the magnet units has a tubular-member abutting portion that abuts the radially inner surface of the tubular member.

### CROSS-REFERENCE TO RELATED APPLICATIONS

The present application is a continuation application of International Application No. PCT/JP2017/046474 filed on Dec. 25, 2017, which is based on and claims priority from Japanese Patent Application No. 2016-251981 filed on Dec. 26, 2016. The contents of these applications are hereby incorporated by reference in their entirety into the present application.

### BACKGROUND

### 1 Technical Field

The present invention relates to rotors and rotating electric machines which include the rotors.

### 2 Description of Related Art

Conventionally, rotating electric machines have been known which are used in, for example, vehicles as electric motors and electric generators. In these rotating electric machines, a rotor is arranged radially inside a stator to radially face the stator. The rotor includes a field core and a field winding. The field core is comprised of a pair of pole cores. Each of the pole cores has a boss portion, a disc portion extending radially outward from an axially outer end portion of the boss portion, and a plurality of claw-shaped magnetic pole portions axially extending from the disc portion and located radially outside the boss portion. The claw-shaped magnetic pole portions of the pole cores are provided at a predetermined angular pitch around a rotating shaft. The claw-shaped magnetic pole portions of the pole cores respectively form magnetic poles the polarities of which are alternately different in a circumferential direction. The field winding is arranged between the boss portions and the claw-shaped magnetic pole portions of the pole cores.

### SUMMARY

According to the present disclosure, there is provided a rotor which includes: a field core having a plurality of claw-shaped magnetic pole portions that respectively form a plurality of magnetic poles polarities of which are alternately different in a circumferential direction; a tubular member arranged radially outside the claw-shaped magnetic pole portions to cover radially outer surfaces of the claw-shaped magnetic pole portions; a field winding wound on the field core; and a plurality of magnet units each of which includes a permanent magnet arranged between one circumferentially-adjacent pair of the claw-shaped magnetic pole portions and a magnet holder that holds the permanent magnet. The magnet holder has: a pair of circumferential movement restricting portions provided to restrict circumferential movement of the permanent magnet; a first radial movement restricting portion provided to restrict radially inward movement of the permanent magnet; and a pair of second radial movement restricting portions that are respectively provided in spaces, which are formed between circumferential end portions of the radially outer surfaces of the pair of the claw-shaped magnetic pole portions and a radially inner surface of the tubular member, to restrict radially inward movement of the magnet holder. Each of the magnet units has a tubular-member abutting portion that abuts the radially inner surface of the tubular member.

### BRIEF DESCRIPTION OF THE DRAWINGS

FIG. 1 is a cross-sectional view of a rotating electric machine which includes a rotor according to an exemplary embodiment.

FIG. 2 is a plan view, from the radially outside, of the rotor omitting a rotating shaft and cooling fans.

FIG. 3 is a perspective view of the rotor omitting the rotating shaft and the cooling fans.

FIG. 4 is a perspective view of the rotor omitting a tubular member, the rotating shaft and the cooling fans.

FIG. 5 is an axial view of part of the rotor, the part of the rotor including a pair of claw-shaped magnetic pole portions.

FIG. 6 is a perspective view of a magnet holder of a magnet unit included in the rotor.

FIG. 7 is an axial view of part of a rotor according to a first modification, the part of the rotor including a pair of claw-shaped magnetic pole portions.

FIG. 8 is an axial view of part of a rotor according to a second modification, the part of the rotor including a pair of claw-shaped magnetic pole portions.

FIG. 9 is a perspective view of a magnet holder of a magnet unit include in the rotor according to the second modification.

FIG. 10 is an axial view of part of a rotor according to a third modification, the part of the rotor including a pair of claw-shaped magnetic pole portions.

FIG. 11 is a cross-sectional view taken along the line XI-XI in FIG. 10.

FIG. 12 is an axial view of part of a rotor according to a fourth modification, the part of the rotor including a pair of claw-shaped magnetic pole portions.

FIG. 13 is an axial view of part of a rotor according to a sixth modification, the part of the rotor including a pair of claw-shaped magnetic pole portions.

FIG. 14 is a perspective view of a fixing pin of a magnet holder of a magnet unit included in the rotor according to the sixth modification.

FIG. 15 is an axial view of part of a rotor according to a seventh modification, the part of the rotor including a pair of claw-shaped magnetic pole portions.

FIG. 16 is an axial view of part of a rotor according to an eighth modification, the part of the rotor including a pair of claw-shaped magnetic pole portions and a magnet unit that is omitted from FIG. 16.

FIG. 17 is an axial view of part of a rotor according to a ninth modification, the part of the rotor including a pair of claw-shaped magnetic pole portions.

FIG. 18 is an axial view of part of another rotor according to a ninth modification, the part of the rotor including a pair of claw-shaped magnetic pole portions.

FIG. 19 is an axial view of part of a rotor according to a tenth modification, the part of the rotor including a pair of claw-shaped magnetic pole portions.

### DESCRIPTION OF EMBODIMENT

In a rotating electric machine disclosed in JP2007-336723A (to be referred to as Patent Document 1 hereinafter), the rotor includes a plurality of magnet units each of which includes a permanent magnet and a magnet holder that holds the permanent magnet. The permanent magnet is arranged between one circumferentially-adjacent pair of the claw-shaped magnetic pole portions. The magnet holder includes a holder main body having the permanent magnet received in a hollow space thereof, and a holding plate that circumferentially extends on the radially inner side of the holder main body. The holding plate engages with step portions respectively provided in the circumferentially-adjacent pair of the claw-shaped magnetic pole portions, so as to restrict movement of the magnet holder in the centrifugal direction (i.e., in the radially outward direction). Consequently, the centrifugal force acting on the permanent magnet is applied to the claw-shaped magnetic pole portions via the magnet holder.

However, in the rotating electric machine disclosed in Patent Document 1, in each of the magnet units, the magnet holder is required to bear all the centrifugal force acting on the permanent magnet; thus the magnet holder is required to have high strength. Therefore, it is necessary to set the radial thickness of the magnet holder to be large. Consequently, the size of the permanent magnet is limited due to the large radial thickness of the magnet holder. In addition, the radially inward movement of the magnet holder is not restricted. Consequently, when an external force is applied to the permanent magnet due to vibration generated during rotation of the rotor, the permanent magnet and the magnet holder may be together moved radially inward.

On the other hand, in a rotating electric machine disclosed in JP2009-148057A (to be referred to as Patent Document 2 hereinafter), the rotor includes a plurality of permanent magnets and a tubular member (magnetic-pole tubular portion). Each of the permanent magnets is arranged between one circumferentially-adjacent pair of the claw-shaped magnetic pole portions. The tubular member is arranged radially outside the claw-shaped magnetic pole portions to cover radially outer surfaces of the claw-shaped magnetic pole portions. Each of the permanent magnets is arranged in contact with a radially inner surface of the tubular member. With the tubular member, it is possible to magnetically connect each circumferentially-adjacent pair of the claw-shaped magnetic pole portions; it is also possible to suppress the claw-shaped magnetic pole portions (more specifically, distal end portions thereof) from being deformed radially outward due to the centrifugal force during rotation of the rotor.

Moreover, in the rotating electric machine disclosed in Patent Document 2, the permanent magnets are arranged in contact with the radially inner surface of the tubular member, so that radially outward movement of the permanent magnets due to the centrifugal force during rotation of the rotor can be suppressed by the tubular member. However, the permanent magnets are not held on the radially inner side. Consequently, when an external force is applied to the permanent magnets due to vibration generated during rotation of the rotor, the permanent magnets may be moved radially inward.

In contrast, in the above-described rotor according to the present disclosure, in each of the magnet units, the permanent magnet is sandwiched between the first radial movement restricting portion of the magnet holder and the radially inner surface of the tubular member with the pair of second radial movement restricting portions of the magnet holder respectively abutting the corresponding circumferential end portions of the radially outer surfaces of the claw-shaped magnetic pole portions and the tubular-member abutting portion abutting the radially inner surface of the tubular member. Consequently, it becomes possible to restrict radial movement of the permanent magnet and thus that of the magnet unit. Moreover, the permanent magnet is held by the pair of circumferential movement restricting portions of the magnet holder while being located in the gap formed between the circumferentially-adjacent pair of the claw-shaped magnetic pole portions. Consequently, it also becomes possible to restrict circumferential movement of the permanent magnet and thus that of the magnet unit. As a result, it becomes possible to restrict movement in every direction of the magnet units each including the permanent magnet and the magnet holder.

In a further implantation, in each of the magnet units, the tubular-member abutting portion is provided in the magnet holder, and the magnet holder is formed of a softer material than the tubular member. With this configuration, when each of the magnet units is fitted into the spaces, it is possible to prevent the radially inner surface of the tubular member from being damaged due to interference between the radially inner surface and the magnet holder. Consequently, it is possible to prevent the mechanical strength of the tubular member form being lowered.

In another further implementation, in each of the magnet units, the magnet holder further has an axial movement restricting portion provided to restrict axial movement of the permanent magnet. With this configuration, it is possible to fix, by the axial movement restricting portion of the magnet holder, the position of the permanent magnet in the axial direction. As a result, it is possible to prevent the permanent magnet from being detached in the longitudinal direction thereof from the magnet holder and even from the rotor.

In yet further implementation, in each of the magnet units, the magnet holder further has a pair of elastic portions respectively provided on circumferential side surfaces of the magnet holder, which respectively face corresponding circumferential side surfaces of the claw-shaped magnetic pole portions, to protrude respectively from the circumferential side surfaces of the magnet holder to the corresponding circumferential side surfaces of the claw-shaped magnetic pole portions. With this configuration, each of the magnet units is elastically supported in the circumferential direction by the elastic portions. Consequently, it is possible to reliably position each of the magnet units in the circumferential direction in the rotor.

In still further implementation, each of the magnet units is fixed to the tubular member and the pair of the claw-shaped magnetic pole portions by magnetic attraction force of the permanent magnet. With this configuration, each of the magnet units is not bonded, but detachably fixed to the tubular member and the claw-shaped magnetic pole portions by the magnetic attraction force of the permanent magnet. Consequently, when there is a difference in the amount of deflection of each of the claw-shaped magnetic pole portions between the distal end side and the proximal end side (or root side) under the centrifugal force, it is possible to suppress the twisting force due to the difference from acting on each of the magnet units. As a result, it is possible to preventing damage (e.g. cracking) from occurring in each of the magnet units.

In a further implementation, each of the magnet units further includes an elastically-deformable skin member that has an adhesive property and is provided on a surface of the permanent magnet. With this configuration, it is possible to fix the permanent magnet and peripheral members (e.g., the magnet holder and the tubular member) by the adhesive included in the skin member. Consequently, the bonding strength of the permanent magnet in the rotor can be increased. Moreover, it is also possible to absorb, when there is a difference in the amount of deflection of each of the claw-shaped magnetic pole portions between the distal end side and the proximal end side under the centrifugal force, the twisting force due to the difference. Consequently, it is possible to suppress the twisting force due to the difference from acting on the permanent magnet, thereby preventing damage (e.g., cracking) from occurring in the permanent magnet.

In still further implementation, the skin member includes: a first skin portion provided between the permanent magnet and the magnet holder; and a second skin portion provided between the permanent magnet and the tubular member. With this configuration, it is possible to improve the bonding strength between the permanent magnet and the magnet holder by the first skin portion and the bonding strength between the permanent magnet and the tubular member by the second skin portion.

In another further implementation, each of the magnet units further has a pair of pin members each of which is inserted in: (1) a gap formed between a corresponding one of the second radial movement restricting portions, the radially inner surface of the tubular member and a corresponding one of circumferential side surfaces of the permanent magnet with the second radial movement restricting portions respectively abutting the radially outer surfaces of the pair of the claw-shaped magnetic pole portions; or (2) a gap formed between a corresponding one of the second radial movement restricting portions, a corresponding one of the circumferential end portions of the radially outer surfaces of the pair of the claw-shaped magnetic pole portions and a corresponding one of the circumferential movement restricting portions with the second radial movement restricting portions both abutting the radially inner surface of the tubular member. Each of the pin members extends in a rod shape along the axial direction. With this configuration, the second radial movement restricting portions are sandwiched between the corresponding pin members and the corresponding circumferential end portions of the radially outer surfaces of the claw-shaped magnetic pole portions or between the corresponding pin members and the radially inner surface of the tubular member. Consequently, it is possible to prevent the magnet holder and thus the magnet unit from being detached in the axial direction from the corresponding claw-shaped magnetic pole portions and the tubular member.

In yet another implementation, the magnet holders of the magnet units are formed of a soft-magnetic material. With this configuration, when the rotating electric machine is under a no-load condition, it is possible to short-circuit, with the magnet holders, magnetic flux emanating from the permanent magnets, thereby suppressing generation of counterelectromotive force.

In still another implementation, the second radial movement restricting portions are respectively fitted in the spaces to substantially entirely fill the spaces. With this configuration, since the spaces are substantially entirely filled with the magnet holder that is formed of the soft-magnetic material, it is possible to compensate, with the magnet holder, those magnetic path portions which are lost due to the cuts provided in the claw-shaped magnetic pole portions for forming the spaces. Consequently, it is possible to suppress d-axis magnetic force from being lowered due to the cuts provided in the claw-shaped magnetic pole portions.

In a further implementation, in each of the magnet units, the magnet holder has a radially outer surface that is convex in an arc shape toward the radially inner surface of the tubular member. At least part of the radially outer surface of the magnet holder abuts, as the tubular-member abutting portion of the magnet unit, the radially inner surface of the tubular member. The tubular-member abutting portion is in a state of pressing the tubular member radially outward with the second radial movement restricting portions serving as fulcrums and under an elastic force generated by the magnet holder. With this configuration, inter-claw portions of the tubular member, which are respectively located at the same circumferential positions as inter-claw spaces between the claw-shaped magnetic pole portions, are pressed radially outward by the elastic force generated by the magnet holder. Therefore, it is difficult for the inter-claw portions of the tubular member from becoming recessed with respect to other portions of the tubular member. That is, it is possible to maintain the arc-shape of the inter-claw portions of the tubular member. Consequently, it is possible to alleviate stress concentration in the tubular member, thereby preventing damage from occurring in the tubular member.

According to the present disclosure, there is also provided a rotating electric machine which includes: the rotor according to the present disclosure; and a stator arranged radially outside to radially face the rotor. With this configuration, in the rotating electric machine, it is possible to achieve the advantageous effects described above.

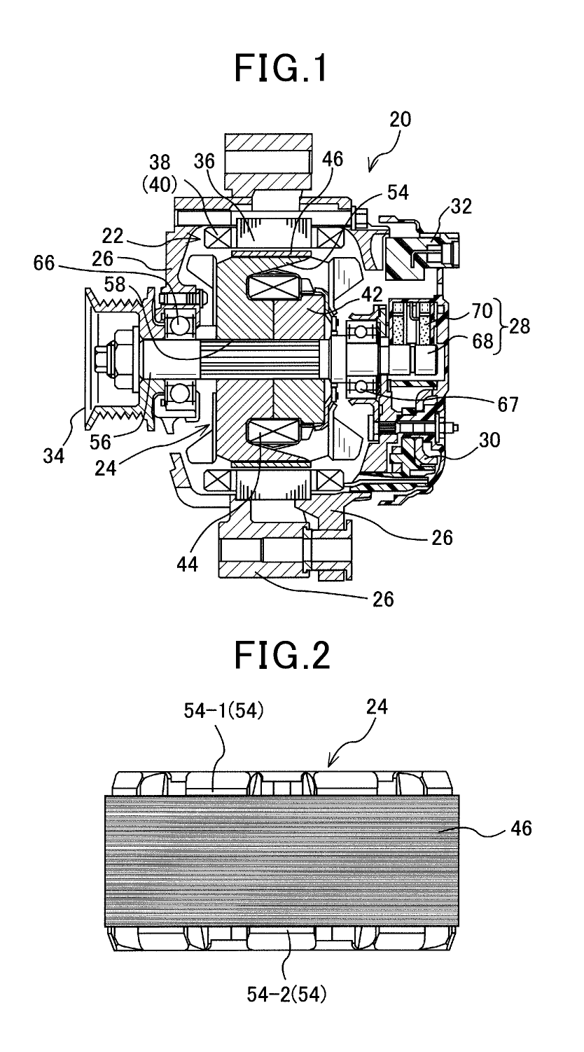

Hereinafter, an exemplary embodiment and modifications thereof will be described with reference to FIGS. 1-19.

In this embodiment, the rotating electric machine 20 is used in, for example, a vehicle. Upon being supplied with electric power from a power source such as a battery, the rotating electric machine 20 generates drive power for driving the vehicle. Otherwise, upon being supplied with drive power (or torque) from an engine of the vehicle, the rotating electric machine 20 generates electric power for charging the battery.

As shown in FIG. 1, the rotating electric machine 20 includes a stator 22, a rotor 24, a housing 26, a brush device 28, a rectifier 30, a voltage regulator 32 and a pulley 34.

The stator 22, which constitutes part of a magnetic circuit formed in the rotating electric machine 20, generates an electromotive force upon the application of a rotating magnetic field with rotation of the rotor 24. The stator 22 includes a stator core 36 and a stator winding (or armature winding) 38. The stator core 36 is hollow cylindrical-shaped. In the present embodiment, the stator core 36 is formed by laminating a plurality of magnet steel sheets, which are made of iron or silicon steel, in the axial direction. The stator core 36 has an annular shaped (or hollow cylindrical shaped) back yoke core, a plurality of teeth extending radially inward from the back yoke core and arranged at predetermined intervals in the circumferential direction, and a plurality of slots each being formed between one circumferentially-adjacent pair of the teeth.

The stator winding 38 is wound on the stator core 36 (more specifically, on the teeth). The stator winding 38 has in-slot portions received in the slots of the stator core 36, and a pair of coil end parts 40 that respectively protrude from an opposite pair of axial ends of the stator core 36. The stator winding 38 is a multi-phase winding, more particularly three-phase winding in the present embodiment. The stator winding 38 includes three phase windings each of which is electrically connected to an inverter (not shown). Voltages applied to the phase windings of the stator winding 38 are controlled by controlling switching of a plurality of switching elements included in the inverter.

The rotor 24 is arranged radially inside the stator 22 to face the stator 22 (more specifically, distal ends of the teeth) with a predetermined air gap formed therebetween. In other words, the stator 22 and the rotor 24 are arranged to radially face each other through the predetermined air gap. The rotor 24, which also constitutes part of the magnetic circuit, forms magnetic poles upon supply of electric current to a field winding 44 which will be described later.

In the present embodiment, the rotor 24 is configured as a Lundell rotor. Specifically, as shown in FIGS. 1-3, the rotor 24 includes a field core 42, the field winding 44, a tubular member 46 and a plurality of magnet units 48.

The field core 42 is comprised of a pair of pole cores. Each of the pole cores has a boss portion 50, a disc portion 52 and a plurality of claw-shaped magnetic pole portions 54. The boss portion 50 is cylindrical-shaped and has a shaft hole 58 formed along its central axis. In the shaft hole 58, there is fitted and fixed a rotating shaft 56. The disc portion 52 is disc-shaped and extends radially outward from an axially outer end portion of the boss portion 58. Each of the claw-shaped magnetic pole portions 54 is connected with a radially outer end of the disc portion 52 and protrudes in a claw shape from the radially outer end of the disc portion 52 axially inward. That is, each of the claw-shaped magnetic pole portions 54 is located radially outside the boss portion 50.

In addition, the pole cores are by, for example, forging. Each of the claw-shaped magnetic pole portions 54 of the pole cores has a radially outer surface 54a formed in a substantially arc shape.

Hereinafter, for the sake of convenience, the claw-shaped magnetic pole portions 54 of one of the pair of pole cores will be referred to as first claw-shaped magnetic pole portions 54-1 and the claw-shaped magnetic pole portions 54 of the other of the pair of pole cores will be referred to as second claw-shaped magnetic pole portions 54-2. The first claw-shaped magnetic pole portions 54-1 are arranged at predetermined intervals in the circumferential direction of the rotor 24. The second claw-shaped magnetic pole portions 54-2 are also arranged at predetermined intervals in the circumferential direction of the rotor 24. The number of the first claw-shaped magnetic pole portions 54-1 and the number of the second claw-shaped magnetic pole portions 54-2 are set to the same number (e.g., eight). The polarity (e.g., N) of the magnetic poles formed by the first claw-shaped magnetic pole portions 54-1 and the polarity (e.g., S) of the magnetic poles formed by the second claw-shaped magnetic pole portions 54-2 are different from (or opposite to) each other. The pair of pole cores are assembled to each other so that the first claw-shaped magnetic pole portions 54-1 are arranged alternately with the second claw-shaped magnetic pole portions 54-2 in the circumferential direction. Moreover, as shown in FIG. 4, between each circumferentially-adjacent pair of the first and second claw-shaped magnetic pole portion 54-1 and 54-2, there is formed a gap 60.

More specifically, the first claw-shaped magnetic pole portions 54-1 and the second claw-shaped magnetic pole portions 54-2 are alternately arranged in the circumferential direction so that proximal end portions (or distal end portions) of the first claw-shaped magnetic pole portions 54-1 are on the axially opposite side to those of the second claw-shaped magnetic pole portions 54-2. The first claw-shaped magnetic pole portions 54-1 protrude from the corresponding disc portion 52 to a first axial side (i.e., the lower side in FIG. 4). On the other hand, the second claw-shaped magnetic pole portions 54-2 protrude from the corresponding disc portion 52 to a second axial side (i.e., the upper side in FIG. 4). In addition, the first claw-shaped magnetic pole portions 54-1 and the second claw-shaped magnetic pole portions 54-2 are identically shaped except for the positions at which they are arranged and the axial sides to which they protrude.

Each of the claw-shaped magnetic pole portions 54 is formed to have a predetermined width in the circumferential direction (i.e., circumferential width) and a predetermined thickness in the radial direction (i.e., radial thickness). Moreover, each of the claw-shaped magnetic pole portions 54 is formed so that both the circumferential width and radial thickness of the claw-shaped magnetic pole portion 54 gradually decrease from the proximal end portion of the claw-shaped magnetic pole portion 54 in the vicinity of the corresponding disc portion 52 to the distal end portion of the claw-shaped magnetic pole portion 54. In other words, each of the claw-shaped magnetic pole portions 54 is formed so as to become thinner in both the circumferential and radial directions from the proximal end portion thereof to the distal end portion thereof. In addition, it is preferable that each of the claw-shaped magnetic pole portions 54 is formed symmetrically with respect to a circumferential center thereof.

As described above, each of the gaps 60 is formed between one circumferentially-adjacent pair of the first and second claw-shaped magnetic pole portion 54-1 and 54-2. Moreover, each of the gaps 60 extends obliquely with respect to the axial direction (i.e., are oblique at a predetermined angle to the rotating shaft 56 of the rotor 24). Furthermore, each of the gaps 60 is formed so that its circumferential dimension (i.e., circumferential size) hardly changes with the axial position, in other words, its circumferential dimension is kept at a constant value or within a very narrow range which includes the constant value. In each of the gaps 60, there is arranged one of the magnet units 48; as will be described in detail later, each of the magnet units 48 includes a permanent magnet 62.

The field winding 44 is arranged in a radial gap between the boss portions 50 and the claw-shaped magnetic pole portions 54 of the pair of pole cores. Upon direct current flowing therethrough, the field winding 44 causes magnetic flux to be generated in the field core 42. The field winding 44 generates magnetomotive force upon being energized. The field winding 44 is wound around the boss portions 50 of the pair of pole cores. The magnetic flux generated by the field winding 44 is guided, via the boss portions 50 and the disc portions 52, to the claw-shaped magnetic pole portions 54. In other words, the boss portions 50 and the disc portions 52 together form magnetic paths for guiding the magnetic flux generated by the field winding 44 to the claw-shaped magnetic pole portions 54. The field winding 44 magnetizes, with the generated magnetic flux, the first claw-shaped magnetic pole portions 54-1 into N poles and the second claw-shaped magnetic pole portions 54-2 into S poles.

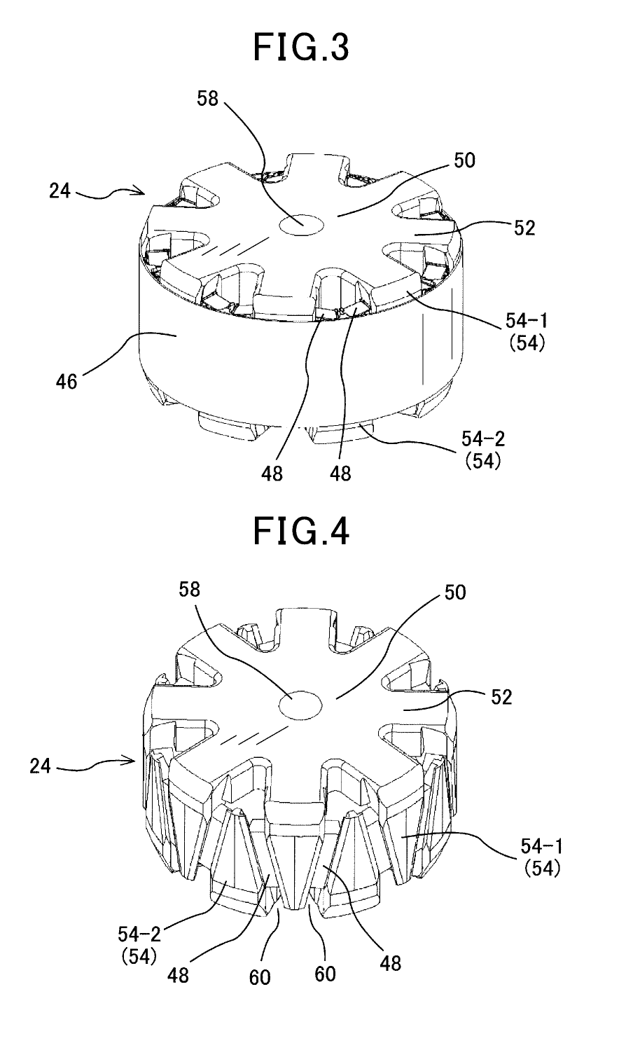

As shown in FIGS. 2 and 3, the tubular member 4 is substantially cylindrical-shaped and arranged radially outside the claw-shaped magnetic pole portions 54 of the pair of pole cores (i.e., the first claw-shaped magnetic pole portions 54-1 and second claw-shaped magnetic pole portions 54-2) to cover the radially outer surfaces 54a of the claw-shaped magnetic pole portions 54. The tubular member 46 has an axial length almost equal to the axial length of the claw-shaped magnetic pole portions 54 (i.e., the axial distance from the proximal end to the distal end in each of the claw-shaped magnetic pole portions 54). Moreover, the tubular member 46 has a predetermined radial thickness W (e.g., about 0.6 mm-1.0 mm with which it is possible to ensure both mechanical strength and magnetic performance in the rotor 24). The tubular member 46 is arranged to face the radially outer surface 54a of each of the claw-shaped magnetic pole portions 54 and abut each of the claw-shaped magnetic pole portions 54. The tubular member 46 closes the gaps 60, each of which is formed between one circumferentially-adjacent pair of the first and second claw-shaped magnetic pole portions 54-1 and 54-2, on their radially outer side, thereby magnetically connecting these claw-shaped magnetic pole portions 54-1 and 54-2.

The tubular member 46 is formed of a metal material having a soft-magnetic property. The tubular member 46 may be constituted of: a pipe-like member formed in a cylindrical shape; a laminate in which a plurality of sheets shaped by blanking are laminated in the axial direction; or a member formed by winding or rolling a wire. The tubular member 46 is fixed to the claw-shaped magnetic pole portions 54 by shrink fitting, press fitting, welding or any combination of the aforementioned methods. In addition, in terms of strength and magnetic performance, it is preferable for the sheets or wire forming the tubular member 46 to be formed of a square bar having a rectangular cross section; however, they may also be formed or a round wire or a member with rounded corners.

The tubular member 46 has a function of smoothing the radially outer periphery of the rotor 24 and thereby reducing wind noise caused by unevenness of the radially outer periphery of the rotor 24. Moreover, the tubular member 46 also has a function of connecting the claw-shaped magnetic pole portions 54, which are arranged in the circumferential direction, to one another and thereby suppressing deformation (more particularly, radial deformation) of each of the claw-shaped magnetic pole portions 54 under the centrifugal force applied thereto.

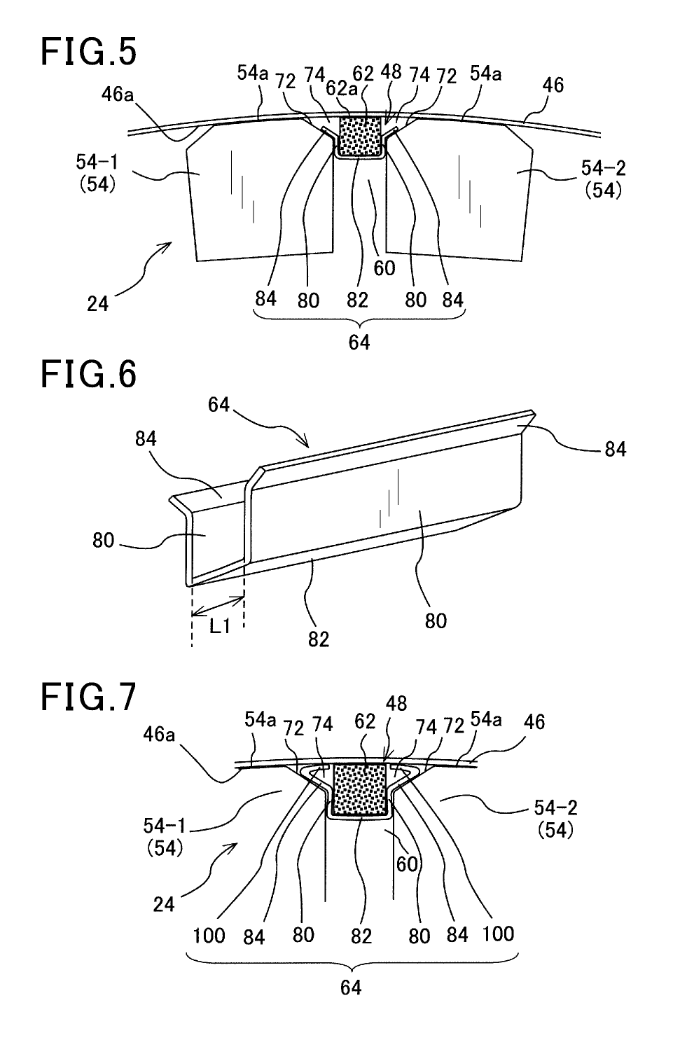

As shown in FIGS. 5 and 6, each of the magnet units 48 includes a permanent magnet 62 and a magnet holder 64. Each of the magnet units 48 covers at least part of the permanent magnet 62 with the magnet holder 64, and holds and fixes the permanent magnet 62 to the rotor 24 using the magnet holder 64. The permanent magnet 62 is an inter-pole magnet which is received on the radially inner side of the tubular member 46 and arranged to fill the gap 60 formed between one circumferentially-adjacent pair of the claw-shaped magnetic pole portions 54 (i.e., one first claw-shaped magnetic pole portion 54-1 and one second claw-shaped magnetic pole portion 54-2). The magnet holder 64 is a holding member for holding the permanent magnet 62 as described in detail later. Each of the magnet units 48 is bonded to the tubular member 46 and the claw-shaped magnetic pole portions 54 by, for example, a liquid adhesive.

In each of the gaps 60, there is arranged one of the permanent magnets 62. That is, the number of the permanent magnets 62 is equal to the number of the gaps 60. Accordingly, both the number of the magnet holders 64 and the number of the magnet units 48 are also equal to the number of the gaps 60. Each of the permanent magnet 62 is formed in a substantially cuboid shape. Moreover, each of the permanent magnet 62 extends obliquely with respect to the axial direction (i.e., is oblique at a predetermined angle to the rotating shaft 56 of the rotor 24). The permanent magnets 62 have a function of reducing leakage of magnetic flux between the claw-shaped magnetic pole portions 54 and thereby intensifying magnetic flux transferred between the claw-shaped magnetic pole portions 54 and the stator core 36 of the stator 22.

The permanent magnets 62 are provided to form magnetic poles that are oriented to reduce leakage magnetic flux between each circumferentially-adjacent pair of the claw-shaped magnetic pole portions 54. That is, each of the permanent magnets 62 is magnetized so that the magnetomotive force acts in the circumferential direction. Specifically, each of the permanent magnets 62 is configured to have its N pole formed at a circumferential surface thereof facing the first claw-shaped magnetic pole portion 54-1 to be magnetized into an N pole and its S pole formed at a circumferential surface thereof facing the second claw-shaped magnetic pole portion 54-2 to be magnetized into an S pole. In addition, the permanent magnets 56 may be assembled into the rotor 24 after being magnetized or be magnetized after being assembled into the rotor 24.

As shown in FIG. 1, the housing 26 accommodates both the stator 22 and the rotor 24 therein. The housing 26 rotatably supports the rotating shaft 56 and the rotor 24 via a pair of bearings 66 and 67, and fixes the stator 22.

The brush device 28 includes a pair of slip rings 68 and a pair of brushes 70. The slip rings 68 are fixed to one axial end portion (i.e., a right end portion in FIG. 1) of the rotating shaft 56 and have a function of supplying direct current to the field winding 44 of the rotor 24. The brushes 70 are held by a brush holder that is mounted and fixed to the housing 26. Each of the brushes 70 is arranged in a state of being pressed to the rotating shaft 56 side so that a radially inner end portion of the brush 70 can slide on the surface of a corresponding one of the slip rings 68. The brushes 70 supply direct electric current to the field winding 44 via the slip rings 68.

The rectifier 30 is electrically connected with the stator winding 38 of the stator 22. The rectifier 30 rectifies alternating current generated in the stator winding 38 into direct current and outputs the resultant direct current. The voltage regulator 32 is a device which regulates an output voltage of the rotating electric machine 20 by controlling the field current (i.e., direct current) supplied to the field winding 44. The voltage regulator 32 has a function of keeping the output voltage substantially constant which otherwise varies according to electrical loads and the amount of electric power generated by the rotating electric machine 20. The pulley 34 is provided to transmit rotation of the engine of the vehicle to the rotor 24 of the rotating electric machine 20. The pulley 34 is fixed, by fastening, on another axial end portion (i.e., a left end portion in FIG. 1) of the rotating shaft 56.

In the rotating electric machine 20 having the above-described structure, when direct current is supplied from the electric power source to the field winding 44 of the rotor 24 via the brush device 28, the supply of the direct current causes magnetic flux to be generated which flows through the boss portions 50, disc portions 52 and claw-shaped magnetic pole portions 54 of the pair of pole cores, penetrating the field winding 44. The magnetic flux forms a magnetic circuit along which the magnetic flux flows in the order of, for example, the boss portion 50 of one of the pair of pole cores→the disc portion 52 of the one of the pair of pole cores→the first claw-shaped magnetic pole portions 54-1→the stator core 36→the second claw-shaped magnetic pole portions 54-2→the disc portion 52 of the other of the pair of pole cores→the boss portion 50 of the other of the pair of pole cores→the boss portion 50 of the one of the pair of pole cores.

Upon the above-described magnetic flux being guided to the first and second claw-shaped magnetic pole portions 54-1 and 54-2, each of the first claw-shaped magnetic pole portions 54-1 is magnetized into an N pole whereas each of the second claw-shaped magnetic pole portions 54-2 is magnetized to an S pole. With the claw-shaped magnetic pole portions 54 magnetized in the above manner, three-phase alternating current, which is converted from the direct current supplied from the electric power source, is supplied to the stator winding 38, causing the rotor 24 to rotate relative to the stator 22. Consequently, it becomes possible to cause the rotating electric machine 20 to function as an electric motor that rotates with the supply of electric power to the stator winding 38.

Moreover, the rotor 24 of the rotating electric machine 20 rotates upon transmission of torque from the engine of the vehicle to the rotating shaft 56 via the pulley 34. With the rotation of the rotor 24, a rotating magnetic field is applied to the stator winding 38 of the stator 22, causing AC electromotive force to be generated in the stator winding 38. The AC electromotive force generated in the stator winding 38 is rectified by the rectifier 30 into direct current, and the resultant direct current is supplied to the battery. Consequently, it becomes possible to cause the rotating electric machine 20 to function as an electric generator that generates the electromotive force in the stator winding 38, thereby charging the battery.

Next, the characteristic configuration of the rotor 24 according to the present embodiment will be described.

In the rotor 24 of the rotating electric machine 20, the radially outer surface 54a of each of the claw-shaped magnetic pole portions 54 is substantially arc-shaped, conforming to the tubular member 46, at the circumferential center of the claw-shaped magnetic pole portion 54. At radially outer ends of circumferential side surfaces of each of the claw-shaped magnetic pole portions 54, there are respectively provided two cuts. The cuts are formed by cutting off (or removing) corner portions of the claw-shaped magnetic pole portion 54 between the radially outer surface 54a and the circumferential side surfaces of the claw-shaped magnetic pole portion 54. In the case of the pole cores being formed by forging, the cuts are formed as R-chamfered (or rounded) portions for extending the die service life or suppressing occurrence of burrs. Otherwise, the cuts are formed as C-chamfered portions for suppressing magnetic noise.

The circumferential side surfaces of each of the claw-shaped magnetic pole portions 54 are separated, due to the cuts, from a radially inner surface 46a of the tubular member 46. Hereinafter, connecting surfaces that connect the radially outer surface 54a with the circumferential side surfaces in each of the claw-shaped magnetic pole portions 54 will be referred to as cut surfaces 72. That is, each of the claw-shaped magnetic pole portions 54 has a substantially arc-shaped radially outer surface 54a formed at the circumferential center thereof and a pair of cut surfaces 72 formed respectively at the circumferential ends thereof.

Between the cut surfaces 72 of the claw-shaped magnetic pole portions 54 and the radially inner surface 46a of the tubular member 46, there are formed spaces 74. The spaces 74 extend in the same direction as the gaps 60. That is, the spaces 74 extend obliquely at a predetermined angle with respect to the rotating shaft 56 of the rotor 24 from one axial side to the other axial side.

Moreover, in the rotor 24 of the rotating electric machine 20, there are provided the magnet units 48 each of which is constituted of one permanent magnet 62 and one magnet holder 64 that holds the permanent magnet 62. The permanent magnet 62 is arranged in the gap 60 formed between one circumferentially-adjacent pair of the claw-shaped magnetic pole portions 54. The magnet holder 64 is a member for holding and fixing the permanent magnet 62 in the gap 60. The magnet holder 64 covers all or part of the surface of the permanent magnet 62. The magnet holder 64 is formed of a soft-magnetic material having a property of being attracted by a magnet, such as iron or the like. As shown in FIGS. 5 and 6, the magnet holder 64 has a pair of circumferential movement restricting portions (or walls) 80, a first radial movement restricting portion (or wall) 82 and a pair of second radial movement restricting portions (or walls) 84.

Each of the circumferential movement restricting portions 80 restricts circumferential movement of the permanent magnet 62 by abutting all or part of a corresponding one of circumferential side surfaces of the permanent magnet 62. Each of the circumferential movement restricting portions 80 is plate-shaped to face a corresponding one of the circumferential side surfaces of the claw-shaped magnetic pole portions 54 which faces in the circumferential direction (more specifically, to be parallel to that the circumferential side surface). Moreover, each of the circumferential movement restricting portions 80 extends radially as well as obliquely with respect to the axial direction of the rotor 24. Each of the circumferential movement restricting portions 80 has a length, corresponding to the axial length of the permanent magnet 62, in the direction oblique to the axial direction of the rotor 24. Moreover, each of the circumferential movement restricting portions 80 has a radial length smaller than or equal to the radial length of the permanent magnet 62. In addition, in FIG. 5, there is shown the case of each of the circumferential movement restricting portions 80 having a smaller radial length than the permanent magnet 62.

The circumferential movement restricting portions 80 are arranged to be separated from each other by a predetermined distance L1 in the circumferential direction (more precisely, in a direction slightly inclined from the circumferential direction to the axial direction by an angle corresponding to the predetermined angle at which the gap 60 extends obliquely with respect to the axial direction). Moreover, the circumferential movement restricting portions 80 are arranged in the gap 60 so as to respectively face the corresponding circumferential side surfaces of the claw-shaped magnetic pole portions 54 while circumferentially sandwiching the permanent magnet 62 therebetween. The predetermined distance L1 described above is substantially equal to the circumferential width of the permanent magnet 62. In addition, the predetermined distance L1 may alternatively be set to be slightly larger than the circumferential width of the permanent magnet 62.

The first radial movement restricting portion 82 restricts radially inward movement of the permanent magnet 62 by abutting all or part of a radially inner surface of the permanent magnet 62. The first radial movement restricting portion 82 is plate-shaped to be parallel to the radially inner surface of the permanent magnet 6. Moreover, the first radial movement restricting portion 82 extends circumferentially as well as obliquely with respect to the axial direction of the rotor 24. The first radial movement restricting portion 82 is connected integrally with radially inner end portions of the circumferential movement restricting portions 80. That is, the first radial movement restricting portion 82 is formed to connect the radially inner end portions of the circumferential movement restricting portions 80 in the circumferential direction. Consequently, the magnet holder 64 has a U-shaped cross section formed by the first radial movement restricting portion 82 and the circumferential movement restricting portions 80.

Each of the second radial movement restricting portions 84 restricts radially inward movement of the magnet holder 64 by abutting all or part of a corresponding one of the cut surfaces 72 of the claw-shaped magnetic pole portions 54. Each of the second radial movement restricting portions 84 is arranged in the space 74 formed between the corresponding cut surface 72 and the radially inner surface 46a of the tubular member 46. Moreover, each of the second radial movement restricting portions 84 is plate-shaped to be parallel to the corresponding cut surface 72 that is formed at the radially outer end of one of the circumferential side surfaces of one of the claw-shaped magnetic pole portions 54. Each of the second radial movement restricting portions 84 extends circumferentially as well as obliquely with respect to the axial direction of the rotor 24.

Moreover, each of the second radial movement restricting portions 84 is connected integrally with a radially outer end portion of a corresponding one of the circumferential movement restricting portions 80. Each of the second radial movement restricting portions 84 is formed to extend from the corresponding circumferential movement restricting portion 80 to a circumferential side opposite to that circumferential side where the first radial movement restricting portion 82 is connected with corresponding circumferential movement restricting portion 80. Consequently, the magnet holder 64 has a flange shape formed by the pair of second radial movement restricting portions 84.

In each of the magnet units 48 as described above, the permanent magnet 62 is restricted in circumferential movement with respect to the magnet holder 64 by the circumferential movement restricting portions 80 of the magnet holder 64 as well as in radially inward moment with respect to the magnet holder 64 by the first radial movement restricting portion 82 of the magnet holder 64.

The magnet holder 64 has its circumferential movement restricting portions 80 arranged in the gap 60 so as to respectively face the corresponding circumferential side surfaces of the claw-shaped magnetic pole portions 54 and its second radial movement restricting portions 84 arranged in the spaces 74 so as to respectively face the corresponding cut surfaces 72 of the claw-shaped magnetic pole portions 54. With this arrangement, the magnet holder 64 is restricted in circumferential movement by the circumferential movement restricting portions 80 as well as in radially inward movement by the second radial movement restricting portions 84. Accordingly, the permanent magnet 62 held by the magnet holder 64 is restricted in radially inward movement while being circumferentially positioned with respect to the claw-shaped magnetic pole portions 54.

With the magnet holder 64 arranged as described above, the permanent magnet 62 held by the magnet holder 64 presses the magnet holder 64 radially inward with a radially inner surface of the permanent magnet 62 abutting the first radial movement restricting portion 82 of the magnet holder 64 while pressing the tubular member 46 radially outward with a radially outer surface 62a of the permanent magnet 62 abutting the radially inner surface 46a of the tubular member 46. Moreover, the magnet holder 64 is supported by one circumferentially-adjacent pair of the claw-shaped magnetic pole portions 54 with the second radial movement restricting portions 84 of the magnet holder 64 respectively abutting the corresponding cut surfaces 72 of the claw-shaped magnetic pole portions 54. In addition, in each of the magnet units 48, the radially outer surface 62a of the permanent magnet 62 constitutes a tubular-member abutting portion of the magnet unit 48 which abuts the radially inner surface 46a of the tubular member 46.

That is, each of the magnet units 48 having the permanent magnet 62 covered with the magnet holder 64 is fitted into the gap 60 and the spaces 74 on the radially inner side of the tubular member 46. Consequently, the permanent magnet 62 is sandwiched (or fixedly held) between the first radial movement restricting portion 82 of the magnet holder 64 and the radially inner surface 46a of the tubular member 46 in a state of pressing the magnet holder 64 radially inward to have the second radial movement restricting portions 84 of the magnet holder 64 respectively abutting the corresponding cut surfaces 72 of the claw-shaped magnetic pole portions 54. As a result, the permanent magnet 62 is restricted from moving radially outward.

As above, in the rotor 24 of the rotating electric machine 20, the magnet holder 64 of each of the magnet units 48, which holds the permanent magnet 62, has the second radial movement restricting portions 84 arranged in the spaces 74 to respectively abut the corresponding cut surfaces 72 of the claw-shaped magnetic pole portions 54 and thereby restrict radially inward movement of the magnet holder 64. Moreover, the permanent magnet 62 of each of the magnet units 48, which is held by the magnet holder 64, has its radially outer surface 62a abutting the radially inner surface 46a of the tubular member 46. With the above structure, the permanent magnet 62 is sandwiched between the first radial movement restricting portion 82 of the magnet holder 64 and the radially inner surface 46a of the tubular member 46 with the second radial movement restricting portions 84 of the magnet holder 64 respectively abutting the corresponding cut surfaces 72 of the claw-shaped magnetic pole portions 54. Consequently, it becomes possible to fix the position of the permanent magnet 62 and the magnet holder 64 in the radial direction.

In the rotor 24, the permanent magnet 62 of each of the magnet units 48 is arranged radially inside the tubular member 46 to abut the radially inner surface 46a of the tubular member 46. Consequently, the permanent magnet 62 and thus the magnet unit 48 including the permanent magnet 62 are restricted, by the tubular member 46, from being moved radially outward with respect to the claw-shaped magnetic pole portions 54 due to the centrifugal force generated during rotation of the rotating electric machine 20. As a result, the permanent magnet 62 and thus the magnet unit 48 including the permanent magnet 62 are prevented from being detached from the rotor 24 to the radially outside.

Moreover, in each of the magnet units 48, the permanent magnet 62 is arranged radially outside the first radial movement restricting portion 82 of the magnet holder 64 to abut the first radial movement restricting portion 82. The magnet unit 48 is arranged to have the second radial movement restricting portions 84 of the magnet holder 64, which are arranged in the spaces 74, respectively abutting the corresponding cut surfaces 72 of the claw-shaped magnetic pole portions. Consequently, the permanent magnet 62 and the magnet holder 64 holding the permanent magnet 62 are restricted from being moved radially inward. As a result, when an external force is applied to the permanent magnet 62 or the magnet unit 48 including the permanent magnet 62 due to vibration generated during rotation of the rotating electric machine 20, it is still possible to suppress the permanent magnet 62 and thus the magnet unit 48 from being moved radially inward with respect to the claw-shaped magnetic pole portions 54.

Furthermore, in each of the magnet units 48, the permanent magnet 62 is arranged to face both the circumferential movement restricting portions 80 of the magnet holder 64; the circumferential movement restricting portions 80 are arranged in the gap 60 to respectively face the corresponding circumferential side surfaces of the claw-shaped magnetic pole portions 54. Consequently, it becomes possible to suppress the permanent magnet 62 and the magnet holder 64 that holds the permanent magnet 62 from being moved in the circumferential direction. As a result, it becomes possible to fix the position of the permanent magnet 62 and the magnet holder 64 in the circumferential direction.

The fixing of the positions of the permanent magnet 62 and the magnet unit 48 in both the radial and circumferential directions is accomplished by forming the cuts as chamfered portions of the claw-shaped magnetic pole portions 54 and fitting the second radial movement restricting portions 84 of the magnet holder 64 into the spaces 74 formed between the cut surfaces 72 of the claw-shaped magnetic pole portions 54 and the radially inner surface 46a of the tubular member 46. Consequently, it becomes possible to easily fix the position of each of the magnet units 48 with respect to the claw-shaped magnetic pole portions 54 and the field core 42 without performing complicated processing on the claw-shaped magnetic pole portions 54 or the magnet units 48 and without employing additional components.

Moreover, in the rotor 24, all the centrifugal force acting on the permanent magnets 62 is borne by the magnet holder 64, not the magnet holders 64. Therefore, it is unnecessary for the magnet holders 64 to have high strength. For example, it is unnecessary to set the radial thickness of the magnet holders 64 to a value capable of withstanding the centrifugal force acting on the respective permanent magnets 62. Consequently, it becomes possible to prevent the size of the permanent magnets 62 from being limited due to the size of the magnet holders 64.

Moreover, in the rotor 24, the centrifugal force acting on the permanent magnet 62 is not applied to the claw-shaped magnetic pole portions 54. The centrifugal force acting on the claw-shaped magnetic pole portions 54 and the centrifugal force acting on the permanent magnet 62 are not concentrated, but distributed in the tubular member 46. Consequently, it becomes possible to suppress the claw-shaped magnetic pole portions 54 of the rotor 24 from spreading radially outward during rotation of the rotating electric machine 20. As a result, it becomes possible to set the radial air gap between the rotor 24 and the stator 22 to be small, thereby securing high output of the rotating electric machine 20. In addition, since stress due to the centrifugal force is distributed (i.e., not concentrated) in the tubular member 46, it becomes possible to secure high strength of the tubular member 46 against the centrifugal force.

Furthermore, in the rotor 24, the magnet holders 64 that cover the respective permanent magnets 62 are formed of a soft-magnetic material such as iron or the like. Therefore, when the rotating electric machine 20 is under a no-load condition, it is possible to short-circuit, with the magnet holders 64, magnetic flux emanating from the permanent magnets 62, thereby suppressing generation of counterelectromotive force and preventing damage to devices of load circuits.

As described above, the rotor 24 according to the present embodiment includes: the field core 42 having the claw-shaped magnetic pole portions 54 that respectively form the magnetic poles the polarities of which are alternately different in the circumferential direction; the tubular member 46 arranged radially outside the claw-shaped magnetic pole portions 54 to cover the radially outer surfaces 54a of the claw-shaped magnetic pole portions 54; the field winding 44 wound on the field core 42; and the magnet units 48 each of which includes one permanent magnet 62 arranged between one circumferentially-adjacent pair of the claw-shaped magnetic pole portions 54 and one magnet holder 64 that holds the permanent magnet 62. The magnet holder 64 has: the pair of circumferential movement restricting portions 80 provided to restrict circumferential movement of the permanent magnet 62; the first radial movement restricting portion 82 provided to restrict radially inward movement of the permanent magnet 62; and the pair of second radial movement restricting portions 84 that are respectively arranged in the spaces 74, which are formed between the circumferential end portions (i.e., the cut surfaces 72) of the radially outer surfaces 54a of the pair of the claw-shaped magnetic pole portions 54 and the radially inner surface 46a of the tubular member 46, to restrict radially inward movement of the magnet holder 64. Moreover, each of the magnet units 48 has the tubular-member abutting portion (i.e., the radially outer surface 62a of the permanent magnet 62 in the present embodiment) that abuts the radially inner surface 46a of the tubular member 46.

With the above configuration, in each of the magnet units 48, the permanent magnet 62 is sandwiched between the first radial movement restricting portion 82 of the magnet holder 64 and the radially inner surface 46a of the tubular member 46 with the pair of second radial movement restricting portions 84 of the magnet holder 64 respectively abutting the corresponding cut surfaces 72 of the claw-shaped magnetic pole portions 54 and the tubular-member abutting portion abutting the radially inner surface 46a of the tubular member 46. Consequently, it becomes possible to restrict radial movement of the permanent magnet 62 and thus that of the magnet unit 48. Moreover, the permanent magnet 62 is held by the pair of circumferential movement restricting portions 80 of the magnet holder 64 while being located in the gap 60 formed between the circumferentially-adjacent pair of the claw-shaped magnetic pole portions 54. Consequently, it also becomes possible to restrict circumferential movement of the permanent magnet 62 and thus that of the magnet unit 48. As a result, it becomes possible to restrict movement in every direction of the magnet units 48 each including the permanent magnet 62 and the magnet holder 64.

Moreover, in the rotor 24 according to the present embodiment, the magnet holders 64 of the magnet units 48 are formed of a soft-magnetic material. With this configuration, when the rotating electric machine 20 is under a no-load condition, it is possible to short-circuit, with the magnet holders 64, magnetic flux emanating from the permanent magnets 62, thereby suppressing generation of counterelectromotive force.

### [First Modification]

In the above-described embodiment, in each of the magnet units 48, the radially outer surface 62a of the permanent magnet 62 constitutes the tubular-member abutting portion of the magnet unit 48 which abuts the radially inner surface 46a of the tubular member 46.

As an alternative, as shown in FIG. 7, in each of the magnet units 48, in addition to the radially outer surface 62a of the permanent magnet 62, the magnet holder 64 may also constitute tubular-member abutting portions of the magnet unit 48 which abut the radially inner surface 46a of the tubular member 46.

For example, in this modification, the magnet holder 64 further has a pair of tubular-member abutting portions 100 which abut the radially inner surface 46a of the tubular member 46. The tubular-member abutting portions 100 are respectively arranged in the corresponding spaces 74 formed between the cut surfaces 72 of the claw-shaped magnetic pole portions 54 and the radially inner surface 46a of the tubular member 46. In addition, the tubular-member abutting portions 100 may further be arranged in spaces respectively extending from the corresponding spaces 74 to the corresponding circumferential side surfaces of the permanent magnet 62.

Each of the tubular-member abutting portions 100 is connected integrally with a radially outer end portion of a corresponding one of the second radial movement restricting portion 84, and extends in a plane facing the radially inner surface 46a of the tubular member 46. Each of the tubular-member abutting portions 100 and the corresponding second radial movement restricting portion 84 together form a claw-shaped portion that is fitted in the corresponding space 74.

In the above-described the rotor 24 according to the present modification, in each of the magnet units 48, the pair of circumferential movement restricting portions 80 of the magnet holder 64 are arranged in the gap 60 to respectively face the corresponding circumferential side surfaces of the claw-shaped magnetic pole portions 54; the pair of second radial movement restricting portions 84 of the magnet holder 64 are arranged respectively in the corresponding gaps 74 to respectively face the corresponding cut surfaces 72 of the claw-shaped magnetic pole portions 54; and the pair of tubular-member abutting portions 100 of the magnet holder 64 are arranged respectively in the corresponding gaps 74 to both face the radially inner surface 46a of the tubular member 46.

With the above arrangement, the magnet holder 64 is restricted in circumferential movement via the pair of circumferential movement restricting portions 80, in radially inward movement via the pair of second radial movement restricting portions 84 and in radially outward movement via the pair of tubular-member abutting portions 100. Consequently, the permanent magnet 62 held by the magnet holder 64 is positioned in the circumferential direction with respect to the claw-shaped magnetic pole portions 54; both radially inward movement and radially outward movement of the permanent magnet 62 are restricted.

That is, the permanent magnet 62 is sandwiched between the first radial movement restricting portion 82 of the magnet holder 64 and the radially inner surface 46a of the tubular member 46 with the pair of second radial movement restricting portions 84 of the magnet holder 64 respectively abutting the corresponding cut surfaces 72 of the claw-shaped magnetic pole portions 54 and the pair of tubular-member abutting portions 100 of the magnet holder 64 both abutting the radially inner surface 46a of the tubular member 46. Consequently, it becomes possible to fix the position of the permanent magnet 62 and the magnet holder 64 in the radial direction.

In addition, in the above-describe configuration where the tubular-member abutting portions 100 of the magnet holder 64 abut the radially inner surface 46a of the tubular member 46, it is preferable for the magnet holder 64 to be formed of a softer material than the tubular member 46. In this case, when the magnet unit 48 is fitted into the spaces 74, it is possible to prevent the radially inner surface 46a of the tubular member 46 from being damaged due to interference between the radially inner surface 46a and the magnet holder 64. Consequently, it is possible to prevent the mechanical strength of the tubular member 46 form being lowered.

### [Second Modification]

In the above-described embodiment, the position of each of the permanent magnets 62 is not fixed in the axial direction; thus each of the permanent magnets 62 can move in its longitudinal direction.

As an alternative, the position of each of the permanent magnets 62 may be fixed in the axial direction; each of the permanent magnets 62 may be restricted from moving in its longitudinal direction.

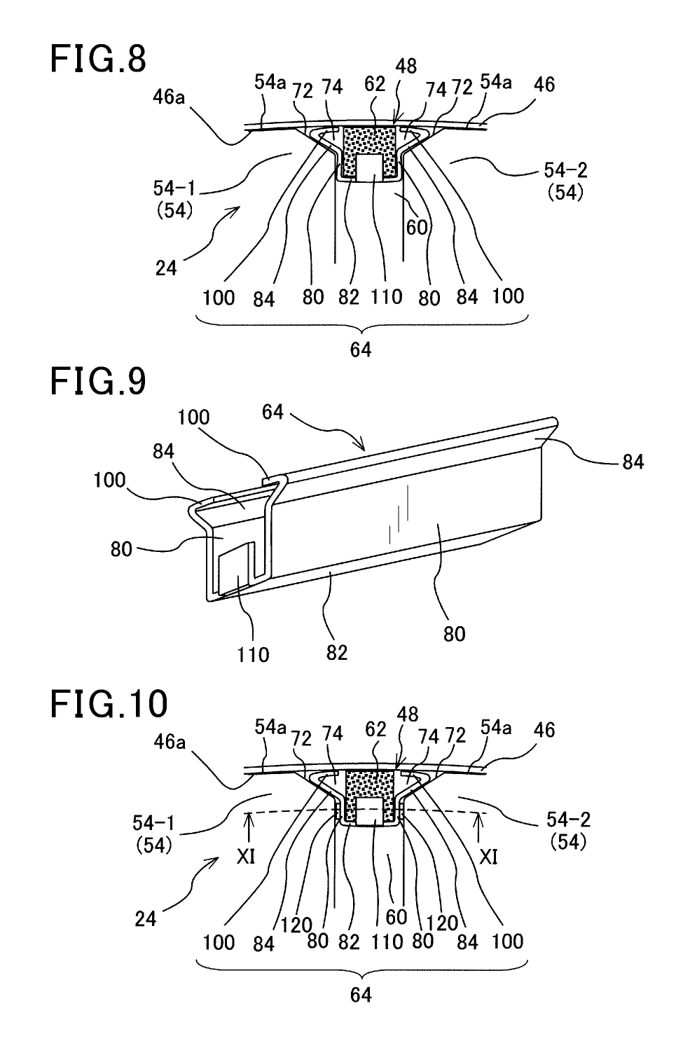

For example, in this modification, as shown in FIGS. 8 and 9, in each of the magnet units 48, the magnet holder 64 further has a pair of axial movement restricting portions 110 for restricting the axial movement of the permanent magnet 62.

Specifically, each of the axial movement restricting portions 110 restricts axial movement of the permanent magnet 62 by abutting all or part of a corresponding one of axial end surfaces of the permanent magnet 62; the axial end surfaces of the permanent magnet 62 face in the axial direction of the rotor 24 or in the longitudinal direction of the permanent magnet 62.

Each of the axial movement restricting portions 110 is plate-shaped to be parallel to a plane perpendicular to the corresponding circumferential side surfaces of the claw-shaped magnetic pole portions 54 which face in the circumferential direction. Each of the axial movement restricting portions 110 also extends radially.

Each of the axial movement restricting portions 110 is connected integrally with a corresponding one of axial end portions of the first radial movement restricting portion 82. Each of the axial movement restricting portions 110 has a circumferential length corresponding to the circumferential width of the permanent magnet 62 or the circumferential width of the gap 60. Moreover, each of the axial movement restricting portions 110 has a radial length smaller than equal to the radial length of the permanent magnet 62. In addition, in FIG. 8, there is shown the case of each of the axial movement restricting portions 110 having a smaller radial length than the permanent magnet 62.

The axial movement restricting portions 110 are arranged to be separated from each other by a predetermined distance L2 in the axial direction (more precisely, in the longitudinal direction of the permanent magnet 62) and to have the permanent magnet 62 sandwiched therebetween in the longitudinal direction. The predetermined distance L2 is equal to or slightly larger than the length of the permanent magnet 62 in the longitudinal direction.

In the above-described the rotor 24 according to the present modification, in each of the magnet units 48, the magnet holder 64 restricts axial movement of the permanent magnet 62 by the axial movement restricting portions 110 that are respectively formed the axial ends of the magnet holder 64. Consequently, it becomes possible to fix, by the axial movement restricting portions 110 of the magnet holder 64, the position of the permanent magnet 62 in the axial direction. As a result, it becomes possible to prevent the permanent magnet 62 from being detached in the longitudinal direction thereof from the magnet holder 64 and even from the rotor 24.

### [Third Modification]

In the above-described embodiment, in each of the magnet units 48, the magnet holder 64 restricts circumferential movement of the permanent magnet 62 by the circumferential movement restricting portions 80. The circumferential movement restricting portions 80 of the magnet holder 64 are arranged in the gap 60 to respectively face the corresponding circumferential side surfaces of the corresponding claw-shaped magnetic pole portions 54 and have the permanent magnet 62 sandwiched therebetween in the circumferential direction.

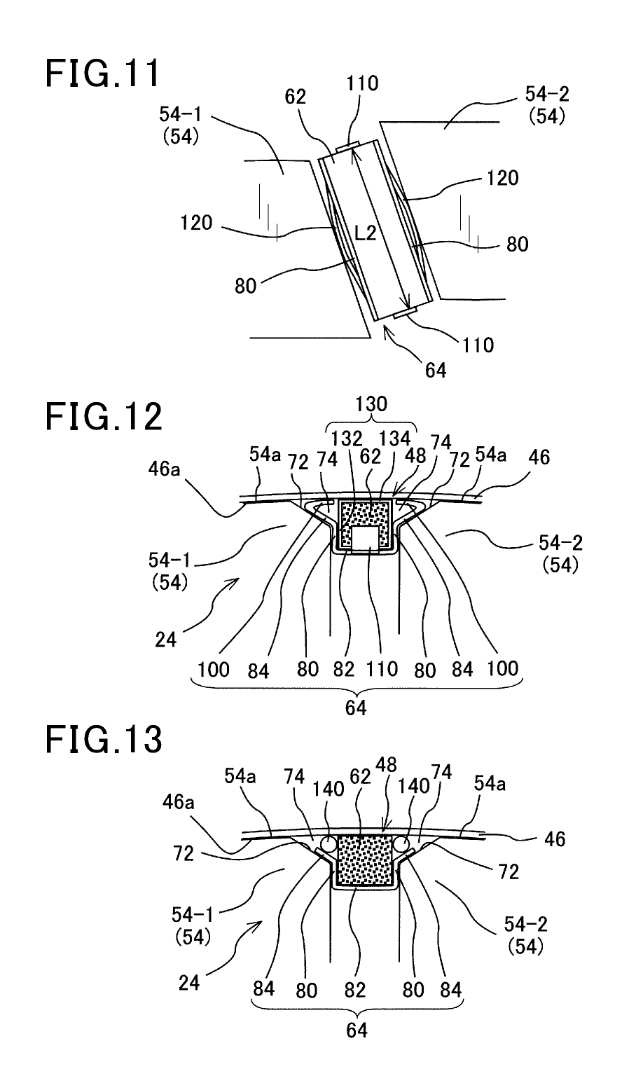

As an alternative, as shown in FIGS. 10 and 11, in each of the magnet units 48, the magnet holder 64 may further has a pair of elastic portions 120 with elasticity arranged in the circumferential direction.

Specifically, in this modification, each of the elastic portions 120 is implemented by a plate spring or the like. Each of the elastic portions 120 is provided on an outer circumferential side surface of a corresponding one of the circumferential movement restricting portions 80; the outer circumferential side surface of the corresponding circumferential movement restricting portion 80 is on the opposite side to an inner circumferential side surface of the corresponding circumferential movement restricting portion 80 which faces the permanent magnet 26. Each of the elastic portions 120 protrudes from the outer circumferential side surface of the corresponding circumferential movement restricting portion 80 outward in the circumferential direction, i.e., toward the circumferential side surface of the claw-shaped magnetic pole portion 54 which faces the corresponding circumferential movement restricting portion 80. The protruding amount of each of the elastic portions 120 is set so that upon the magnet unit 48 having been suitably mounted, a distal end of the elastic portion 120 abuts the circumferential side surface of the claw-shaped magnetic pole portion 54, thereby having the magnet unit 48 elastically supported in the circumferential direction.

With the above configuration, each of the magnet units 48 is elastically supported in the circumferential direction by the elastic portions 120. Consequently, it is possible to reliably position each of the magnet units 48 in the circumferential direction in the rotor 24.

### [Fourth Modification]

In the above-described embodiment, each of the magnet units 48 (in other words, the permanent magnet 62 and the magnet holder 64) is bonded to the tubular member 46 and the claw-shaped magnetic pole portions 54 by the liquid adhesive.

As an alternative, as shown in FIG. 12, each of the magnet units 48 may be fixed to the tubular member 46 and the claw-shaped magnetic pole portions 54 by a skin member 130 mounted on the surface of the permanent magnet 62.

Specifically, in this modification, the skin member 130 is impregnated with an adhesive; therefore, the skin member 130 has an adhesive property and is elastically deformable. The skin member 130 is formed of, for example, a resin. Moreover, the skin member 130 may be implemented by, for example, a member that expands upon application of heat thereto or a foamable member.

In the case of the skin member 130 being implemented by a thermally expanding member, cover part or all of the permanent magnet 62 is covered with the skin member 130 and the permanent magnet 62 is assembled into the field core 42 of the rotor 24. Then, heat is applied to cause the skin member 130 to expand, thereby filling gaps, which are formed in the vicinity of the permanent magnet 62 and the skin member 130, with the skin member 130. Consequently, movement of the permanent magnet 62 in the rotor 24 can be more reliably restricted. Moreover, since the skin member 130 has an adhesive property, it is possible to fix the permanent magnet 62 and peripheral members (e.g., the magnet holder 64 and the tubular member 46) by the adhesive included in the skin member 130. Consequently, the bonding strength of the permanent magnet 62 in the rotor 24 can be increased. Moreover, since the skin member 130 is elastically deformable, it is possible to absorb, when there is a difference in the amount of deflection of each of the claw-shaped magnetic pole portions 54 between the distal end side and the proximal end side (or root side) under the centrifugal force, the twisting force due to the difference. Consequently, it is possible to suppress the twisting force due to the difference from acting on the permanent magnet 62, thereby preventing damage (e.g., cracking) from occurring in the permanent magnet 62.

In addition, as shown in FIG. 12, it is preferable for the skin member 130 to include a first skin portion 132 provided between the permanent magnet 62 and the magnet holder 64 and a second skin portion 134 provided between the permanent magnet 62 and the tubular member 46. With this configuration, it is possible to improve the bonding strength between the permanent magnet 62 and the magnet holder 64 by the first skin portion 132 and the bonding strength between the permanent magnet 62 and the tubular member 46 by the second skin portion 134.

### [Fifth Modification]

In the above-described embodiment, each of the magnet units 48 (in other words, the permanent magnet 62 and the magnet holder 64) is held by being bonded to the tubular member 46 and the claw-shaped magnetic pole portions 54 by the liquid adhesive.

As an alternative, each of the magnet units 48 may be held by magnetic attraction force of the permanent magnet 62 instead of using the liquid adhesive. In other words, each of the magnet units 48 may be fixed to the tubular member 46 and the claw-shaped magnetic pole portions 54 by the magnetic attraction force of the permanent magnet 62.

With the above configuration, each of the magnet units 48 is not bonded, but detachably fixed to the tubular member 46 and the claw-shaped magnetic pole portions 54 by the magnetic attraction force of the permanent magnet 62. Consequently, when there is a difference in the amount of deflection of each of the claw-shaped magnetic pole portions 54 between the distal end side and the proximal end side (or root side) under the centrifugal force, it is possible to suppress the twisting force due to the difference from acting on each of the magnet units 48. As a result, it is possible to preventing damage (e.g. cracking) from occurring in each of the magnet units 48.

### [Sixth Modification]

In the above-described embodiment, in each of the magnet units 48, the pair of second radial movement restricting portions 84 of the magnet holder 64 are arranged to respectively abut the corresponding circumferential end portions (i.e., cut surfaces 72) of the radially outer surfaces 54a of the pair of the claw-shaped magnetic pole portions 54, thereby restricting radially inward movement of the magnet holder 64. With this structure, however, there are formed gaps in the spaces 74 between the second radial movement restricting portions 84 and the radially inner surface 46a of the tubular member 46.

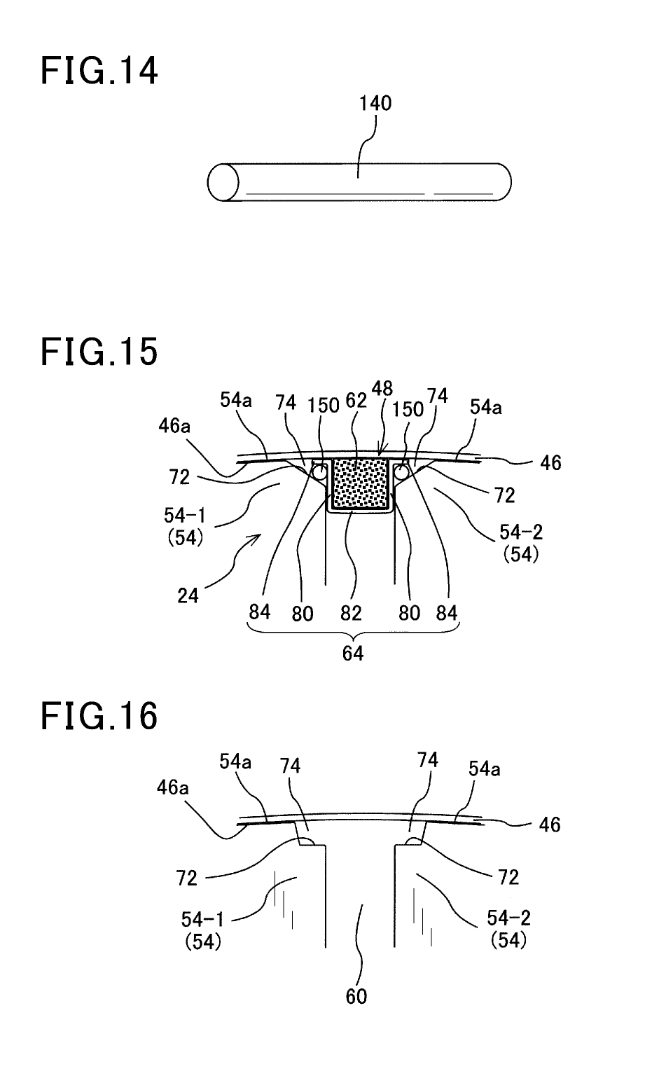

In this modification, as shown in FIG. 13, a pair of pin members 140 are respectively inserted into the gaps to fill the gaps. Specifically, each of the pin members 140 is inserted in the gap between a corresponding one of the second radial movement restricting portions 84 of the magnet holder 64, the radially inner surface 46a of the tubular member 46 and a corresponding one of the circumferential side surfaces of the permanent magnet 62. Each of the pin members 140 extends in a rod shape in the axial direction (more precisely, parallel to the longitudinal direction of the permanent magnet 62). Each of the pin members 140 has a sufficient thickness required to abut the corresponding second radial movement restricting portion 84, the radially inner surface 46a of the tubular member 46 and the corresponding circumferential side surface of the permanent magnet 62; thus each of the pin members 140 can fill the gap. In addition, each of the pin members 140 may be formed in the shape of a round rod as shown in FIG. 14 or in the shape of a rectangular rod (not shown).

With the above configuration, upon each of the pin members 140 being inserted in the gap between the corresponding second radial movement restricting portion 84, the radially inner surface 46a of the tubular member 46 and the corresponding circumferential side surface of the permanent magnet 62, the corresponding second radial movement restricting portion 84 is pressed radially inward by the pin member 140 and sandwiched (or fixedly held) between the pin member 140 and the cut surface 72 of the corresponding claw-shaped magnetic pole portion 54. Consequently, it is possible to prevent the magnet holder 64 and thus the magnet unit 48, which has the permanent magnet 62 held by the magnet holder 64, from being detached in the axial direction from the corresponding claw-shaped magnetic pole portions 54 and the tubular member 46.

In addition, it is preferable to combine this modification with the above-described second modification in which the permanent magnet 62 is prevented, by the axial movement restricting portions 110, from being detached in the longitudinal direction from the magnet holder 64 and even from the rotor 24.

### [Seventh Modification]

In the above-described fifth modification, in each of the magnet units 48, the second radial movement restricting portions 84 of the magnet holder 64 are arranged to respectively abut the corresponding circumferential end portions (i.e., cut surfaces 72) of the radially outer surfaces 54a of the pair of the claw-shaped magnetic pole portions 54; each of the pin members 140 is inserted in the gap between the corresponding second radial movement restricting portion 84, the radially inner surface 46a of the tubular member 46 and the corresponding circumferential side surface of the permanent magnet 62.

As an alternative, in this modification, as shown in FIG. 15, each of the second radial movement restricting portions 84 is arranged on the tubular member 46 side; a pin member 150 is inserted in the axial direction (more precisely, parallel to the longitudinal direction of the permanent magnet 62) into the gap between the second radial movement restricting portion 84, the cut surface 72 of the corresponding claw-shaped magnetic pole portion 54 and the corresponding circumferential movement restricting portion 80, so as to fill the gap. Each of the pin members 140 has a sufficient thickness required to abut the corresponding second radial movement restricting portion 84, the cut surface 72 of the corresponding claw-shaped magnetic pole portion 54 and the corresponding circumferential movement restricting portion 80; thus each of the pin members 150 can fill the gap. In addition, each of the second radial movement restricting portions 84 is not necessarily formed to extend parallel to the cut surface 72 of the corresponding claw-shaped magnetic pole portion 54; instead, each of the second radial movement restricting portions 84 may be formed to extend perpendicular to the corresponding circumferential movement restricting portion 80 or along the radially inner surface 46a of the tubular member 46.

With the above configuration according to the present modification, upon each of the pin members 150 being inserted in the gap between the corresponding second radial movement restricting portion 84, the cut surface 72 of the corresponding claw-shaped magnetic pole portion 54 and the corresponding circumferential movement restricting portion 80, the corresponding second radial movement restricting portion 84 is pressed radially outward by the pin member 150 and sandwiched (or fixedly held) between the pin member 150 and the radially inner surface 46a of the tubular member 46. Consequently, it is possible to prevent the magnet holder 64 and thus the magnet unit 48, which has the permanent magnet 62 held by the magnet holder 64, from being detached in the axial direction from the corresponding claw-shaped magnetic pole portions 54 and the tubular member 46.

In addition, it is preferable to combine the present modification with the above-described second modification in which the permanent magnet 62 is prevented, by the axial movement restricting portions 110, from being detached in the longitudinal direction from the magnet holder 64 and even from the rotor 24.

### [Eighth Modification]

In the above-described embodiment, in each of the claw-shaped magnetic pole portions 54, there are provided the cuts, by cutting off the corner portions of the claw-shaped magnetic pole portion 54, for forming the cut surfaces 72. The cuts may be in a tapered shape, such as an R-chamfered shape or a C-chamfered shape shown in FIG. 5.

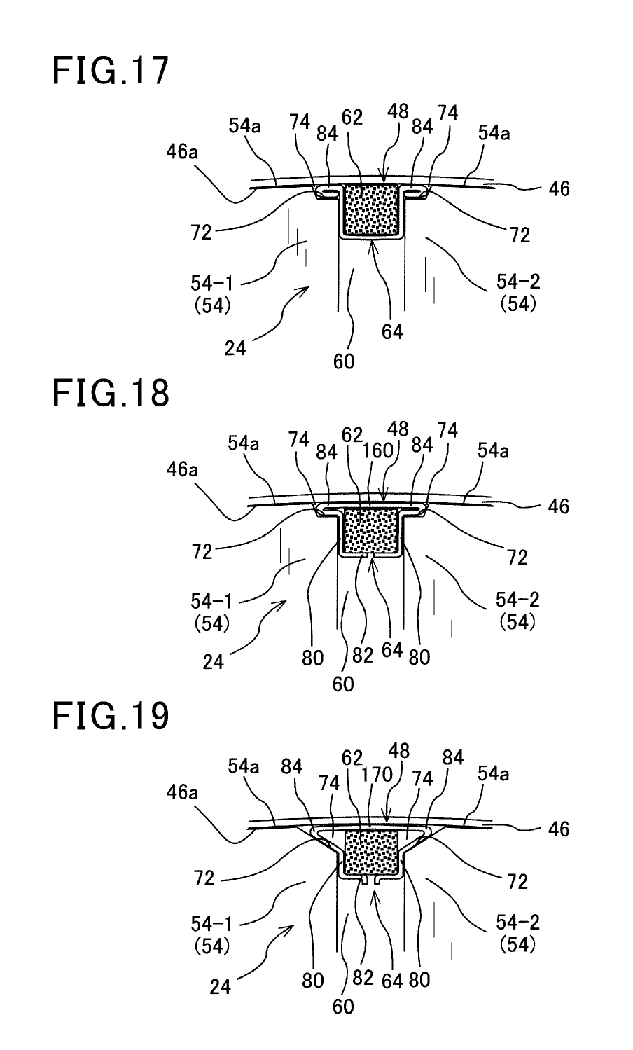

As an alternative, as shown in FIG. 17, the cuts may be formed by deeply cutting off the corner portions of the claw-shaped magnetic pole portion 54 in both the circumferential and radial directions, so as to have a large volume.

That is, the cuts may be formed in any suitable shape such that between the cut surfaces 72 and the radially inner surface 46a of the tubular member 46, there may be formed the spaces 74 into which the second radial movement restricting portions 84 of the magnet holder 64 may be respectively arranged.

### [Ninth Modification]

In the above-described embodiment, in each of the magnet units 48, the second radial movement restricting portions 84 of the magnet holder 64 are respectively arranged in the spaces 74 that are formed between the circumferential end portions (i.e., the cut surfaces 72) of the radially outer surfaces 54a of the pair of the claw-shaped magnetic pole portions 54 and the radially inner surface 46a of the tubular member 46. However, the second radial movement restricting portions 84 of the magnet holder 64 are shaped so as not to entirely fill the spaces 74.

As an alternative, as shown in FIGS. 17 and 18, the second radial movement restricting portions 84 of the magnet holder 64 may be shaped to substantially entirely fill the spaces 74 and be respectively fitted in the spaces 74.

For example, as shown in FIG. 17, circumferential end portions of the plate-shaped magnet holder 64 may be folded to form the second radial movement restricting portions 84 so that each of the second radial movement restricting portions 84 has a plurality of sections overlapping and facing each other in the radial direction. In this case, the second radial movement restricting portions 84 are respectively fitted in the spaces 74 so as to substantially entirely fill the spaces 74; consequently, in the spaces 74, the second radial movement restricting portions 84 abut the corresponding cut surfaces 72 of the claw-shaped magnetic pole portions 54 and the radially inner surface 46a of the tubular member 46.

Otherwise, as shown in FIG. 18, the magnet holder 64 may have: a partition portion 160 by which the permanent magnet 62 and the tubular member 46 are separated from each other; the first radial movement restricting portion 82 divided into two parts in the circumferential direction; and each of the circumferential end portions folded to form one of the second radial movement restricting portions 84. In this case, each of the second radial movement restricting portions 84 has a plurality of sections overlapping and facing each other in the radial direction. The second radial movement restricting portions 84 are connected with each other via the partition portion 160. Moreover, all of the first radial movement restricting portion 82, the circumferential movement restricting portions 80, the second radial movement restricting portions 84 and the partition portion 160 are connected integrally with each other into one piece. Furthermore, the second radial movement restricting portions 84 are respectively fitted in the spaces 74 so as to substantially entirely fill the spaces 74; consequently, in the spaces 74, the second radial movement restricting portions 84 abut the corresponding cut surfaces 72 of the claw-shaped magnetic pole portions 54 and the radially inner surface 46a of the tubular member 46. In addition, the partition portion 160 of the magnet holder 64 constitutes a tubular-member abutting portion of the magnet unit 48 which abuts the radially inner surface 46a of the tubular member 46.

With the above configurations shown in FIGS. 17 and 18, since the spaces 74 are substantially entirely filled with the magnet holder 64 that is formed of the soft-magnetic material, it is possible to compensate, with the magnet holder 64, those magnetic path portions which are lost due to the cuts provided in the claw-shaped magnetic pole portions 54 for forming cut surfaces 72. Consequently, it is possible to suppress d-axis magnetic force from being lowered due to the cuts provided in the claw-shaped magnetic pole portions 54. In addition, the above operational effects can be achieved not only by folding the circumferential end portions of the plate-shaped magnet holder 64 to form the second radial movement restricting portions 84 as described above, but also by fixing (e.g., welding or crimping) a plurality of parts together to form the second radial movement restricting portions 84.

### [Tenth Modification]

In the above-described embodiment, in each of the magnet units 48, the magnet holder 64 has no radially outer surface swollen in an arc-shape toward the radially inner surface 46a of the tubular member 46.

As an alternative, as shown in FIG. 19, in each of the magnet units 48, the magnet holder 64 may be configured to have a radially outer surface 170 that is swollen and thus convex in an arc shape toward the radially inner surface 46a of the tubular member 46. In this case, at least part of the radially outer surface 170 of the magnet holder 48 abuts the radially inner surface 46a of the tubular member 46. That is, at least part of the radially outer surface 170 of the magnet holder 48 constitutes a tubular-member abutting portion of the magnet unit 48. Both circumferential end portions of the radially outer surface 170 are respectively connected integrally with the pair of second radial movement restricting portions 84. The magnet holder 64 generates an elastic force under which the tubular-member abutting portion of the radially outer surface 170 presses, with the second radial movement restricting portions 84 serving as fulcrums, the tubular member 46 radially outward.

In the rotor 24, when the tubular member 46 is mounted to the claw-shaped magnetic pole portions 54 that are arranged at the predetermined intervals in the circumferential direction or when the claw-shaped magnetic pole portions 54 spread radially outward due to the centrifugal force during operation of the rotating electric machine 20, inter-claw portions of the tubular member 46, which are respectively located at the same circumferential positions as the inter-claw spaces between the claw-shaped magnetic pole portions 54, become recessed with respect to other portions of the tubular member 46. Consequently, stress concentration may occur at the boundaries between the recessed inter-claw portions and the other portions of the tubular member 46, causing damage (e.g., cracking) to occur in the tubular member 46.

In contrast, with the above configuration according to the present modification, the inter-claw portions of the tubular member 46, which are respectively located at the same circumferential positions as the inter-claw spaces between the claw-shaped magnetic pole portions 54, are pressed radially outward by the elastic force generated by the magnet holder 64. Therefore, it is difficult for the inter-claw portions of the tubular member 46 from becoming recessed with respect to other portions of the tubular member 46. That is, it is possible to maintain the arc-shape of the inter-claw portions of the tubular member 46. Consequently, it is possible to alleviate stress concentration in the tubular member 46, thereby preventing damage from occurring in the tubular member 46.

While the above particular embodiment and modifications have shown and described, it will be understood by those skilled in the art that various further modifications, changes and improvements may be made without departing from the spirit of the present disclosure. For example, the above-described embodiment and modifications may be combined in any suitable manner to configure a rotor 24 and a rotating electric machine 20 which includes the rotor 24.

What is claimed is:

1. A rotor comprising:
a field core having a plurality of claw-shaped magnetic pole portions that respectively form a plurality of magnetic poles polarities of which are alternately different in a circumferential direction;
a tubular member arranged radially outside the claw-shaped magnetic pole portions to cover radially outer surfaces of the claw-shaped magnetic pole portions;
a field winding wound on the field core; and
a plurality of magnet units each of which includes a permanent magnet arranged between one circumferentially-adjacent pair of the claw-shaped magnetic pole portions and a magnet holder that holds the permanent magnet,
wherein
the magnet holder has:
a pair of circumferential movement restricting portions provided to restrict circumferential movement of the permanent magnet;
a first radial movement restricting portion provided to restrict radially inward movement of the permanent magnet; and
a pair of second radial movement restricting portions that are respectively provided in spaces, which are formed between circumferential end portions of the radially outer surfaces of the pair of the claw-shaped magnetic pole portions and a radially inner surface of the tubular member, to restrict radially inward movement of the magnet holder, and
each of the magnet units has a tubular-member abutting portion that abuts the radially inner surface of the tubular member.

2. The rotor as set forth in claim 1, wherein in each of the magnet units, the tubular-member abutting portion is provided in the magnet holder, and the magnet holder is formed of a softer material than the tubular member.

3. The rotor as set forth in claim 1, wherein in each of the magnet units, the magnet holder further has an axial movement restricting portion provided to restrict axial movement of the permanent magnet.

4. The rotor as set forth in claim 1, wherein in each of the magnet units, the magnet holder further has a pair of elastic portions respectively provided on circumferential side surfaces of the magnet holder, which respectively face corresponding circumferential side surfaces of the claw-shaped magnetic pole portions, to protrude respectively from the circumferential side surfaces of the magnet holder to the corresponding circumferential side surfaces of the claw-shaped magnetic pole portions.

5. The rotor as set forth in claim 1, wherein each of the magnet units is fixed to the tubular member and the pair of the claw-shaped magnetic pole portions by magnetic attraction force of the permanent magnet.

6. The rotor as set forth in claim 1, wherein each of the magnet units further includes an elastically-deformable skin member that has an adhesive property and is provided on a surface of the permanent magnet.

7. The rotor as set forth in claim 6, wherein the skin member includes:
a first skin portion provided between the permanent magnet and the magnet holder; and
a second skin portion provided between the permanent magnet and the tubular member.

8. The rotor as set forth in claim 1, wherein each of the magnet units further has a pair of pin members each of which is inserted in:
a gap formed between a corresponding one of the second radial movement restricting portions, the radially inner surface of the tubular member and a corresponding one of circumferential side surfaces of the permanent magnet with the second radial movement restricting portions respectively abutting the radially outer surfaces of the pair of the claw-shaped magnetic pole portions; or
a gap formed between a corresponding one of the second radial movement restricting portions, a corresponding one of the circumferential end portions of the radially outer surfaces of the pair of the claw-shaped magnetic pole portions and a corresponding one of the circumferential movement restricting portions with the second radial movement restricting portions both abutting the radially inner surface of the tubular member, and
each of the pin members extends in a rod shape along the axial direction.

9. The rotor as set forth in claim 1, wherein the magnet holders of the magnet units are formed of a soft-magnetic material.

10. The rotor as set forth in claim 9, wherein the second radial movement restricting portions are respectively fitted in the spaces to substantially entirely fill the spaces.

11. The rotor as set forth in claim 1, wherein in each of the magnet units, the magnet holder has a radially outer surface that is convex in an arc shape toward the radially inner surface of the tubular member,
at least part of the radially outer surface of the magnet holder abuts, as the tubular-member abutting portion of the magnet unit, the radially inner surface of the tubular member, and
the tubular-member abutting portion is in a state of pressing the tubular member radially outward with the second radial movement restricting portions serving as fulcrums and under an elastic force generated by the magnet holder.

12. A rotating electric machine comprising:
the rotor as set forth in claim 1; and
a stator arranged radially outside to radially face the rotor.
